(19) United States
(12) Patent Application Publication
(10) Pub. No.: US 2023/0420183 A1
(43) Pub. Date: Dec. 28, 2023

(54) System And Method For Producing Rare Earth Magnets From A Metal Powder Using Recycled Materials And Additive Manufacturing

(71) Applicant: MolyWorks Materials Corporation, Cloverdale, CA (US)

(72) Inventors: Christopher Paul Eonta, Los Gatos, CA (US); Matthew Charles, Cloverdate, CA (US)

(73) Assignee: MolyWorks Materials Corporation, Cloverdale, CA (US)

(21) Appl. No.: 18/210,120

(22) Filed: Jun. 15, 2023

Related U.S. Application Data
(60) Provisional application No. 63/354,416, filed on Jun. 22, 2022.

(51) Int. Cl. H01F 41/02; H01F 13/00; B22F 12/30; B22F 12/41; B22F 10/28; B22F 12/50

(52) U.S. Cl. CPC H01F 41/0253; H01F 13/006; B22F 12/30; B22F 12/41; B22F 10/28; B22F 12/50; B33Y 30/00

(57) ABSTRACT

A system for producing rare earth magnets from metal powder includes a melting cold hearth atomization system for producing the metal powder from a scrap material and an additive manufacturing system for building the rare earth magnets using the metal powder and an additive manufacturing process. The melting cold hearth atomization system includes a reactor for melting the scrap material into a molten metal, and one or more atomizers for spheroidizing the molten metal into powder particles that form the metal powder. The additive manufacturing system includes magnetized build plates for aligning the grain structures of the rare earth magnets during a building step of the additive manufacturing process. The scrap material can include recycled rare earth magnets, recycled metal powder containing rare earth metal, and recycled rare earth metal parts.

### CROSS REFERENCE TO RELATED APPLICATION

This application claims priority from U.S. Provisional Ser. No. 63/354,416, filed Jun. 22, 2022, which is incorporated herein by reference.

### FIELD

This disclosure relates to the manufacture of metal powders for additive manufacturing (AM) and in particular to a system and method for producing rare earth magnets from a metal powder using recycled materials and additive manufacturing.

### BACKGROUND

Rare earth magnets are strong permanent magnets made from alloys of rare earth elements. Developed in the 1970s and 1980s, rare earth magnets are the strongest type of permanent magnets made, producing significantly stronger magnetic fields than other types of magnets. One type of rare earth magnet utilizes neodymium (Nd), a metallic element and member of the rare earth group. This type of rare earth magnet is sometimes referred to as a “super magnet”.

For example, Nd—Fe—B magnets are used in cell phones, wind turbines, and electric motors. The United States Military uses Nd—Fe—B magnets for jet fighter engines and other aircraft components, missile guidance systems, electronic countermeasures, underwater mine detection, anti-missile defense, range finding, and space-based satellite power and communication systems.

One problem with the production of rare earth magnets is that mining for Nd—Fe—B often generates other elements such as uranium. Rare earth mining also produces wastewater and tailings ponds that leak acids, heavy metals, and radioactive elements into the groundwater. Rare earth mining and process plants also severely damage surface vegetation, cause soil erosion, pollution and acidification.

Nd—Fe—B is predominantly supplied by China (80% globally) and global demand is outstripping supply by 3,000 tons per year. In 2020 the United States imported 7,200 tons of Nd—Fe—B magnets with 70% coming from China. The US Department of Defense is in a precarious situation for rare earth metals as China has the ability to stop rare earth exports and restrict the world's access to rare earth materials including metals, powder, and magnets.

The rare earth super magnet market is also dominated by China. The United States has little production of rare earth metals, powders, and Nd—Fe—B magnets. China imposes several different types of unfair export restraints on the rare earth metals, including export duties, export quotas, export pricing requirements as well as related export procedures and requirements. As the top global producer, China has artificial control over pricing, increasing prices for the rare earth metals outside of China while lowering prices in China. China's producers have significant pricing advantages when competing against US producers in markets around the world. In addition, China has the ability to control the quality of Nd—Fe—B magnets.

The present system and method recycle rare earth materials to form a sustainable, circular loop for producing rare earth magnets. The system and method reduce the effects of mining and processing on the environment including: reducing mining wastes, raw materials, water pollution, energy consumption, and air pollution. In addition, the present method and system provide the US with rare earth magnets using metal powder produced independently of foreign sources. Other objects, advantages and capabilities of the present system and method will become more apparent as the description proceeds.

### SUMMARY

A system for producing rare earth magnets from a metal powder includes a melting cold hearth atomization system for producing the metal powder from a scrap material and an additive manufacturing system for building the rare earth magnets using the metal powder and an additive manufacturing process. The scrap material can include one or a combination of elements including recycled rare earth magnets, recycled metal powder containing a rare earth element, and recycled metal parts containing rare earth elements.

The melting cold hearth atomization system includes a reactor and a melting cold hearth system in the reactor for melting the scrap material into a molten metal, and combining with other elements if required. The melting cold hearth atomization system also includes one or more atomizers for spheroidizing the molten metal into powder particles that form the metal powder.

The additive manufacturing system can comprise a laser powder bed fusion (LPBF) system, a laser metal deposition (LMD) system, an electron beam deposition (EBM) system, a binder jet 3D printing system, or a fused filament fabrication (FFF) system. In addition, the additive manufacturing system includes magnetized build plates for aligning the grain structures of the magnets during a building step of the additive manufacturing process. The system can also include a demagnetizer system for demagnetizing the scrap material prior to melting, and a sieving or cyclonic system for separating the metal powder into units having a desired particle size range.

A method for producing rare earth magnets from a metal powder includes the steps of: providing a scrap material comprising a rare earth metal, providing a melting cold hearth atomization system for producing the metal powder, demagnetizing the scrap material, melting and atomizing the scrap material into the metal powder using the melting cold hearth atomization system, providing an additive manufacturing system having magnetic build plates, and building the rare earth magnets using the metal powder and the additive manufacturing system. The method can also include the steps of machining the magnets to final dimensions and heat treating the magnets for magnetic properties.

### BRIEF DESCRIPTION OF THE DRAWINGS

Exemplary embodiments are illustrated in the referenced figures of the drawings. It is intended that the embodiments and the figures disclosed herein be considered illustrative rather than limiting.

FIG. 1 is a schematic diagram of a system for producing rare earth magnets from a metal powder;

FIG. 1A is a perspective view of two rare earth magnets fabricated using the system;

FIG. 2A is a side elevation view of a melting cold hearth atomization system of the system;

FIG. 2B is a front elevation view of the melting cold hearth atomization system of the system taken along line 2B-2B of FIG. 2A;

FIG. 2C is a rear elevation view of the melting cold hearth atomization system of the system taken along line 2C-2C of FIG. 2A;

FIG. 3A is a perspective view of a metal powder fabricated using the melting cold hearth atomization system of the system;

FIG. 3B is an enlarged schematic perspective view of a single metal particle of the metal powder;

FIG. 4 is a schematic perspective view of the melting cold hearth atomization system;

FIG. 5 is a schematic perspective view of an atomizer of the melting cold hearth atomization system having an atomization die;

FIG. 5A is a schematic perspective view of an alternate embodiment electrode inert gas atomization (EIGA) atomizer of the melting cold hearth atomization system that utilizes;

FIG. 6A is a schematic view illustrating an additive manufacturing system of the system comprising a laser powder bed fusion (LPBF) system for performing a building step of a method for producing rare earth magnets;

FIG. 6B is a schematic view illustrating an additive manufacturing system of the system comprising a laser metal deposition (LMD) system for performing a building step of the method for producing rare earth magnets;

FIG. 6C is a schematic view illustrating an additive manufacturing system of the system comprising an electron beam melting (EBM) system for performing a building step of the method for producing rare earth magnets;

FIG. 6D is a schematic view illustrating an additive manufacturing system of the system comprising a binder jet 3D printing system for performing a building step of the method for producing rare earth magnets;

FIG. 6E is a schematic view illustrating an additive manufacturing system of the system comprising fused filament fabrication (FFF) system for performing a building step of the method for producing rare earth magnets;

FIGS. 7A-7C are schematic views illustrating build plates and support structures of the additive manufacturing system for performing a building step of the method for producing rare earth magnets; and

FIGS. 8A-8H are perspective views illustrating different geometries for rare earth magnets fabricated using the system.

### DETAILED DESCRIPTION

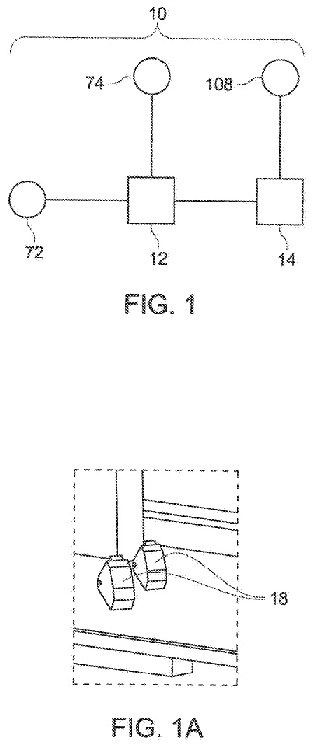

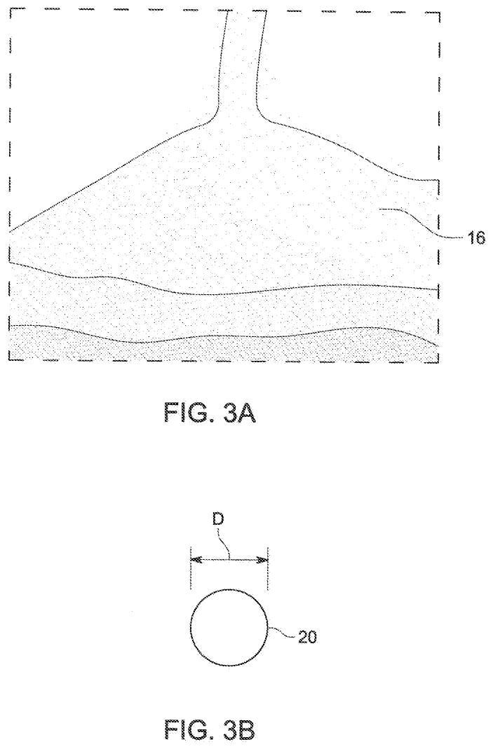

Referring to FIG. 1, FIG. 1A and FIG. 3A, a system 10 (FIG. 1) for producing rare earth magnets 18 (FIG. 1A) from metal powder 16 (FIG. 3A) is shown schematically. The system 10 (FIG. 1) includes a melting cold hearth atomization system 12 (FIG. 1) for producing the metal powder 16 (FIG. 3A) and an additive manufacturing system 14 (FIG. 1) for forming the rare earth magnets 18 (FIG. 1A) using the metal powder 16 (FIG. 3A) and an additive manufacturing process.

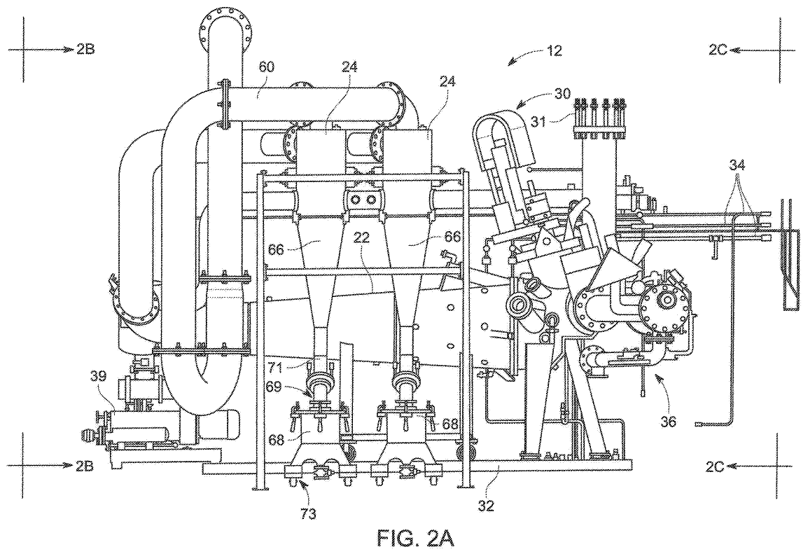

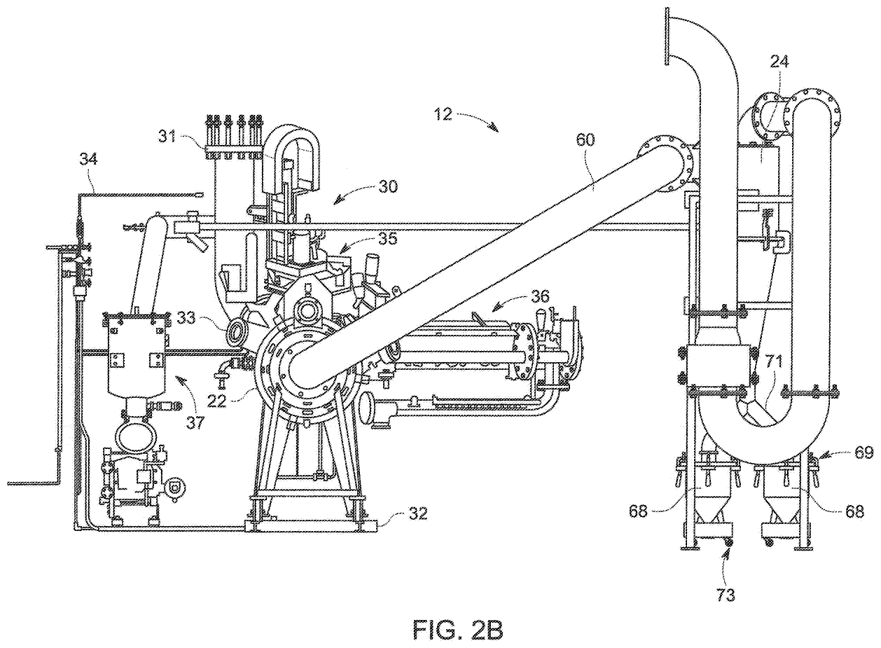

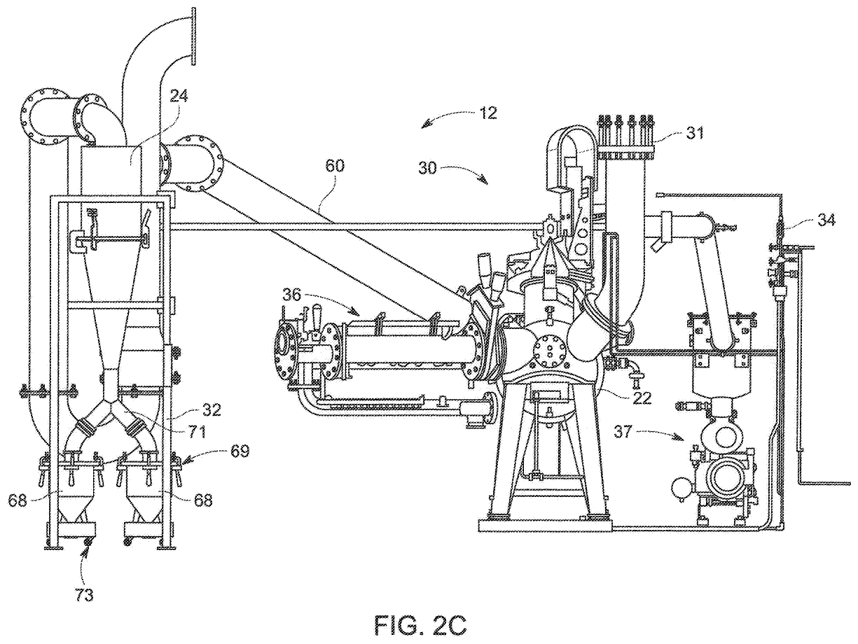

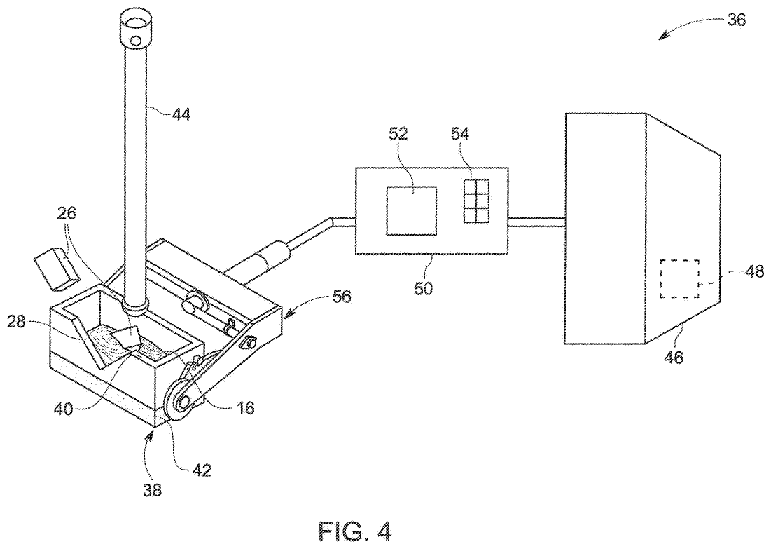

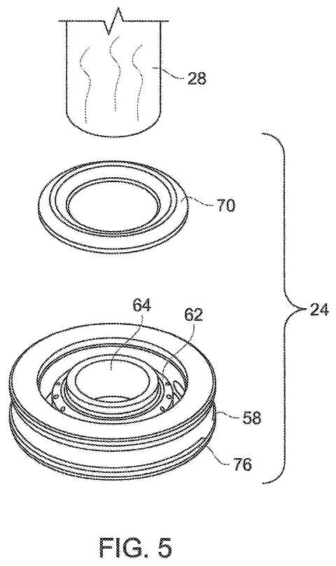

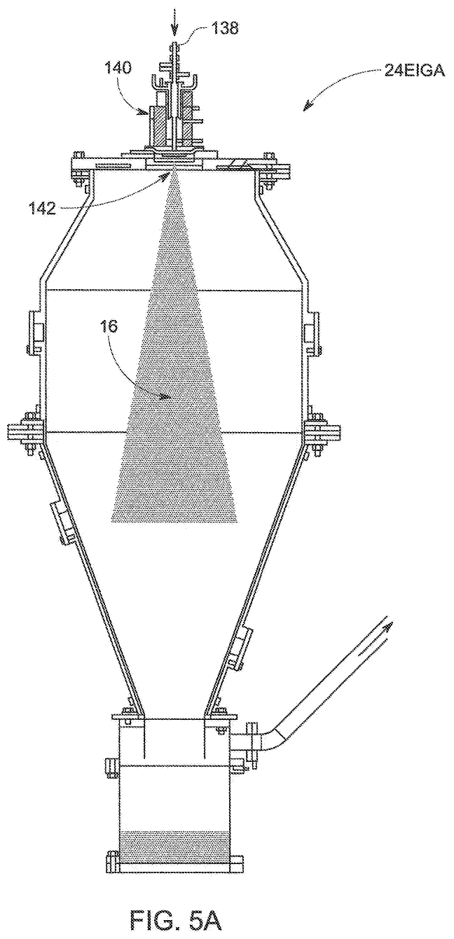

Referring to FIG. 2A, FIG. 2B and FIG. 2C, the melting cold hearth atomization system 12 is illustrated. The melting cold hearth atomization system 12 includes a reactor 22 configured to melt a scrap material 26 (FIG. 4) into a molten metal 28 (FIG. 5) and a pair of atomizers 24 configured to spheroidize the molten metal 28 (FIG. 5) into powder particles 20 (FIG. 3B), which form the metal powder 16 (FIG. 3A).

A support structure 32 supports components of the melting cold hearth atomization system 12 and multiple hydraulic and control lines 34 provide hydraulic fluids as well as electrical and signal communication for components of the melting cold hearth atomization system 12. The melting cold hearth atomization system 12 is mobile as it is sized for transport in a standard sized shipping container (e.g., 8 feet wide×8.5 feet high×10 feet or 20 feet or 30 feet long). A representative capacity of the melting cold hearth atomization system 12 can be about 50 to 100 kg of scrap material 26 an hour with a continuous recharge.

The reactor 22 comprises a sealed vessel configured to operate at an operating pressure, such as at a vacuum pressure, and at high temperatures, to melt the scrap material 26 (FIG. 4) into the molten metal 28 (FIG. 5). The reactor 22 is also configured to add other materials to the scrap material 26 (FIG. 4) including other metals, and additives for performing different functions, such as corrosion resistance without disturbing the operating pressure. The scrap material 26 (FIG. 4) can comprise a recycled metal source that includes a rare earth element. An exemplary source of the scrap material 26 (FIG. 4) can comprise recycled rare earth magnets. The scrap material 26 can also comprise recycled metal powder 16 produced by the system 10, and recycled metal parts.

The melting cold hearth atomization system 12 also includes an automated feeder system 30 for feeding the scrap material 26 (FIG. 4) into the reactor 22 without affecting the pressure within the reactor 22 or the atomizers 24 (e.g., without breaking vacuum). As will be further explained, the feeder system 30 is configured to preserve the heat and vacuum inside the reactor 22, allowing for resupplying of the scrap material 26 (FIG. 4) without stopping the atomizers 24. The feeder system 30 includes an inlet 31 and one or more material handling valves 33 (FIG. 2B) for feeding the scrap material 26 into the reactor 22.

The feeder system 30 can also include a powder feeder system 35 for feeding recycled metal powder 16 into the reactor 22. US Publication No. US-2022-0136769-A1 entitled “Powder Feeder System and Method For Recycling Metal Powder”, which is incorporated herein by reference, describes the powder feeder system 35 in more detail.

The reactor 22 is in flow communication with a vacuum system 37 having a vacuum pump 39 for maintaining the interior of the reactor 22 at a negative pressure. The melting cold hearth atomization system 12 also includes a melting cold hearth system 36 in the reactor 22, which is illustrated schematically in FIG. 4.

Referring to FIG. 4, the melting cold hearth system 36 includes a melting hearth 38 having a melting cavity 40 configured to melt the scrap material 26 into the molten metal 28. The feeder system 30 feeds the scrap material 26, along with scrap metal powder and other materials if required, into the melting cavity 40. The melting hearth 38 also includes an induction coil 42 configured to heat the molten metal 16 in the melting cavity 40. In addition, the melting cold hearth system 36 includes an external heat source 44, such as a plasma torch system, a plasma transferred arc system, an electric arc system, an induction system, a photon system, or an electron beam energy system in close proximity to the melting cavity 40, which is also configured to heat the molten metal 28. A representative power for the heat source 44 in a plasma torch system can be 240-kW. The melting cold hearth system 36 can be configured to form alloys where melt cycles are defined by energy input per weight of material and a characterized vaporization rate can be determined. The melting cold hearth system 36 has composition correction capabilities such that the composition of the molten metal 38 can be determined by the addition of other materials to the melting hearth 38, such as recycled metal powder or metals in pure form, to meet the criteria for the final composition of the metal powder 16 (FIG. 3A). This allows the metal powder 16 (FIG. 3A) to be tailored to the material requirements of different rare earth magnets 18. U.S. Pat. Nos. 9,925,591 and 10,654,106, which are incorporated herein by reference, describe further details of the melting cold hearth 36.

The melting cold hearth system 36 also includes a central processing unit (CPU) 46 for controlling the melting hearth 38. The central processing unit (CPU) 46 can also control a sequence of feeding, melting, pouring and atomizing the molten metal 28. The central processing unit (CPU) 46 can comprise an off the shelf component purchased from a commercial manufacturer and can include one or more computer programs 48. The melting cold hearth system 36 also includes a digital readout 50 in signal communication with the central processing unit (CPU) 46 having a display screen 52 configured to display information and a keypad 54 configured to input information to the central processing unit (CPU) 46. The digital readout 50 can comprise an off the shelf component purchased from a commercial manufacturer. In the illustrative embodiment, the melting hearth 38 also includes a tilting mechanism 56. However, this feature is optional as non-tilting melting hearths can also be employed. US Publication No. US-2023-0139976-A1, entitled “Tilting Melting Hearth System and Method For Recycling Metal”, which is incorporated herein by reference, discloses the tilting mechanism 56 in more detail.

Referring to FIG. 5, components of the atomizers 24 are shown schematically. The atomizers 24 can be configured for either a hot wall atomization process or a cold wall atomization process. By way of example, each atomizer 24 can include an atomization die 58 in flow communication with the reactor 22 via conduit 60 (FIG. 2B). Pressure differentials between the atomizers 24 and the reactor 22 move the molten metal 28 from the reactor 22 to the atomization die 58. The molten metal 28 can be poured from the melting hearth 38 into a flow stream through the conduit 60. The atomization die 58 is configured to receive the molten metal 28 and generate the metal powder 16 (FIG. 3A), which is comprised of the particles 20 (FIG. 3B) each having a desired particle shape and particle size. Each atomization die 58 can include passageways for inert gas jets 62. Each atomization die 58 can also include an orifice 64 in the center and a cover 70. The inert gas jets 62, which are arranged in a circular pattern, impinge inert gas generated by a compressor 76 in flow communication with the jets 62, onto the molten metal 28. In addition, the inert gas jets 62 all converge on the molten metal 28 within the atomization die 58 to disintegrate the molten metal 28 and generate the metal powder 16 (FIG. 3A), while forming the particles 20 (FIG. 3B) with a desired shape (e.g., spherical) and particle size (e.g., diameter D of 1-500 μm). The particles 20 (FIG. 3B) cool in free-fall until reaching the bottom of an atomization tower 66 (FIG. 2A) of the atomizer 24 where the particles 20 are collected in transportable collection vessels 68 (FIG. 2A). The collection vessels 68 (FIG. 2A) have a removable sealing assembly 69 that mates with conduits 71 from the atomizers 24 and a caster assembly 73 for transport. The collection vessels 68 allow the metal powder 16 (FIG. 3A) to be continuously removed during steady state operation of the system 10. The metal powder 16 (FIG. 3A) can then optionally be segregated into units of similar particle size particles 20 using sieving/cyclonic separation.

Referring to FIG. 5A, an alternate embodiment atomizer comprises an electrode inert gas atomization (EIGA) atomizer 24 EIGA configured to melt a rod 138 through an induction coil 140 that falls into a gas nozzle 142 to produce the metal powder 16. In this embodiment the system 10 can be configured to form the molten metal 28 into the rod 138 using a suitable process such as casting.

As shown in FIG. 1, the system 10 can also include a demagnetizer system 72 for demagnetizing the scrap material 26 prior to melting in the melting hearth 38, and a sieving/cyclonic system 74 for separating the particles 20 of the metal powder 16 (FIG. 3A) into a uniform particle size. The demagnetizer system 72 and the sieving system 74 can be constructed using components that are known in the art. For example, the demagnetizer system 72 can comprise a heat-treating furnace. Any particles 20 (FIG. 3B) of the metal powder 16 (FIG. 3A) that do not meet specifications for producing specific rare earth magnets 18 can be recycled. In addition, any non-specification particles 20 (FIG. 3B) can be combined with other scrap materials 26, such as recycled rare earth magnets 18.

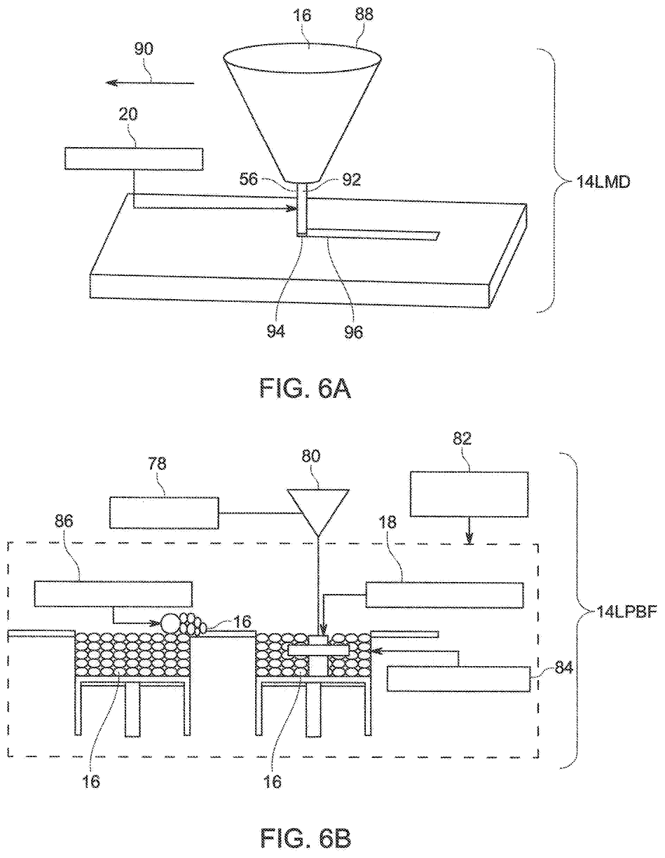

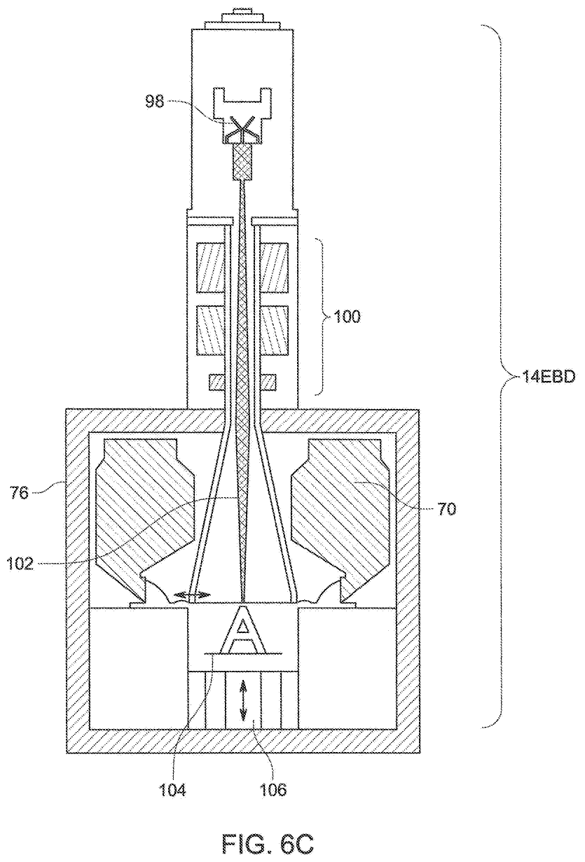

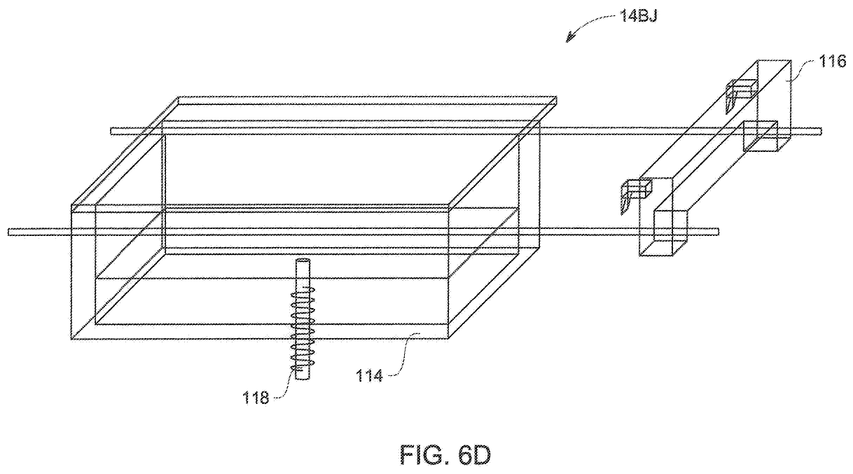

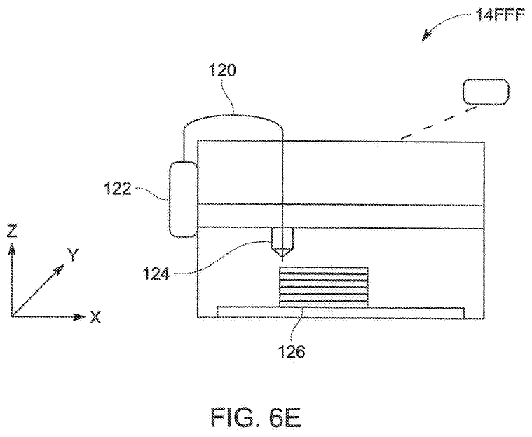

The system 10 (FIG. 1) also includes the additive manufacturing system 14, which is illustrated in three different embodiments in FIG. 6A-6C. Exemplary additive manufacturing systems include: a laser powder bed fusion (LPBF) system 14LPBF (FIG. 6A), a laser metal deposition (LMD) system 14LMD (FIG. 6B), an electron beam deposition (EBM) system 14EBM (FIG. 6C); a binder jet 3D printing system 14BJ (FIG. 6D); and a fused filament fabrication (FFF) system 14FFF (FIG. 6E).

Referring to FIG. 6A, the laser powder bed fusion (LPBF) system 14LPBF employs laser powder bed fusion (LPBF) technology with the metal powder 16 produced to satisfy the requirements of this technology. The laser powder bed fusion (LPBF) system 14LPBF includes a laser 78, a scanner 80, and a build chamber 82. Within the build chamber 82 are a powder bed 84 and for containing the metal powder 16 and a roller rake 86 for conveying the metal powder 16 into the powder bed 84 for building the rare earth magnets 18. Laser powder bed fusion (LPBF) systems 14LPBF are available from commercial manufacturers.

Referring to FIG. 6B, the laser metal deposition (LMD) system 14LMD employs laser metal deposition (LMD) technology with the metal powder 16 produced to satisfy the requirements of this technology. Laser Metal Deposition (LMD) is a type of additive manufacturing process that deposits molten powder directly onto a substrate. LMD can be used for building new parts and part repairs. The powder used in LMD has a particle size range of 75-150 μm. The laser metal deposition (LMD) system 14LMD includes a deposition nozzle 88 in flow communication with a quantity of the metal powder 16 and configured for movement in a direction of travel 90. The deposition nozzle 88 produces moving powder particles 20 that are melted by a laser beam 92 emanated from a laser head (not shown) to form a melt pool 94 and a deposited track 96. Laser metal deposition (LMD) systems 14LMD are available from commercial manufacturers.

Referring to FIG. 6C, the electron beam deposition (EBM) system 14EBM employs electron beam melting (EBM) technology with the metal powder 16 produced to satisfy the requirements of this technology. The electron beam deposition (EBM) system 14EBM includes a filament 98 and a lens system 100 configured to produce an electron beam 102. The electron beam deposition (EBM) system 14EBM can also include a build platform 104 in a vacuum chamber 106 wherein layers of melting powder can be formed into the rare earth magnets 18. Electron beam deposition (EBM) systems 14EBM are available from commercial manufacturers.

Referring to FIG. 6D, the binder jet 3D printing system 14BJ includes a print bed 114, an ink jet 116, and an elevation controller 118. In the binder jet 3D printing system 14BJ, the metal powder 16 is deposited and the ink jet 116 applies a binder, a layer is printed, the metal powder 16 is recoated and the process is repeated. Binder jet 3D printing systems 14BJ are available from commercial manufacturers.

Referring to FIG. 6E, the fused filament fabrication (FFF) system 14FFF uses a continuous filament 120 made of a thermoplastic material. The filament 120 is fed from a spool 122 through a moving, heated print head 124 and is deposited on the printed part 126 in layers. The print head 124 is moved under computer control to define the printed shape. Fused filament fabrication (FFF) systems 14FFF are available from commercial manufacturers.

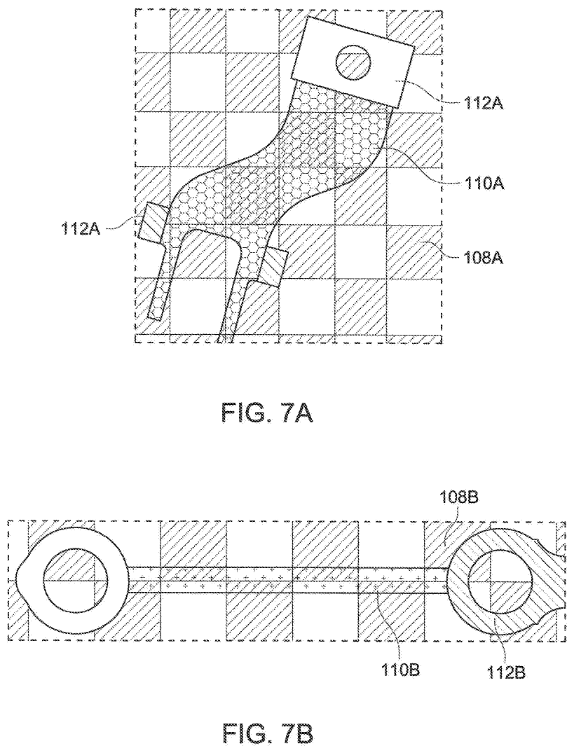

The additive manufacturing system 14 also includes one or more magnetized build plates 108 for performing the building step of the method. FIGS. 7A-7C illustrate exemplary magnetized build plates 108A-108C having build areas 110A-110C and support structures 112A-112C for performing the building step of the additive manufacturing process. The configuration of the build plates 108A-108C, build areas 110A-110C and support structures 112A-112C can be tailored to the geometrical requirements of the rare earth magnets 18. Representative geometrical shapes for the rare earth magnets 18 include spherical, cylindrical, rectangular, triangular, hexagonal, horseshoe, polygonal, as well as complex geometrical shapes. In FIGS. 7A-7C, the build plates 108A-108C are represented by the checkered patterns, the build areas 110A-110C are represented by the honeycomb patterns (or plus minus patterns) and the support structures 112A-112C are represented by solid lines. The build plates 108A-108C can be magnetized using techniques that are known in the art including powder metallurgy and sintering of metals, and compacting and aligning of metal particles with a magnetic field.

In FIG. 7A, a rare earth magnet 18 with a complex geometrical shape can be produced using magnetized build plate 108A. The build plate 108A includes solid support structures 112A that are slightly wider than the base of the rare earth magnets 18 to be built. The support structures 112A can be extruded down from the bottom to enable the build plate 108A to be removed from the completed rare earth magnets 18. Magnetized honeycomb build areas 110A and solid supports 112A can be used for building the rare earth magnets 18. In FIG. 7B, a plus minus build area 110B and solid support structures 112B on a magnetized build plate 108B can be employed to form rare earth magnets 18 with a rectangular plate configuration. All of the build areas 110B beneath and between the support structures 112B can use a plus-sign pattern. In FIG. 7C, the magnetized build plate 108C can be used to form rare earth magnets with a bar bell shape with a hollow cylindrical middle portion. The build plate 108C includes honeycomb magnetized build areas 110C and support structures 112C. External walls can be removed from several areas to ease removal of the support structures 112C after building.

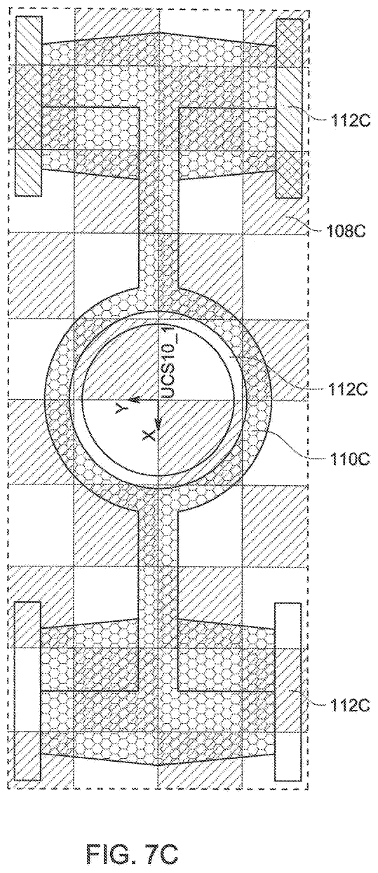

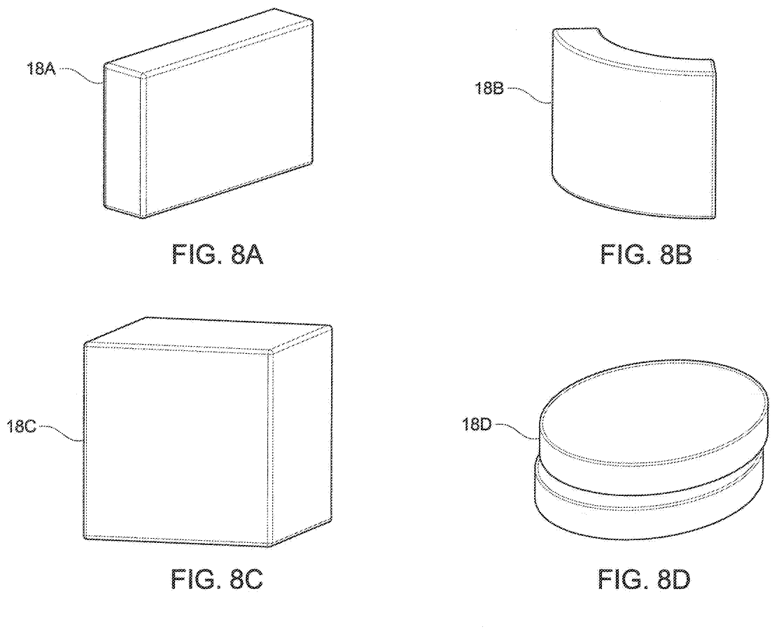

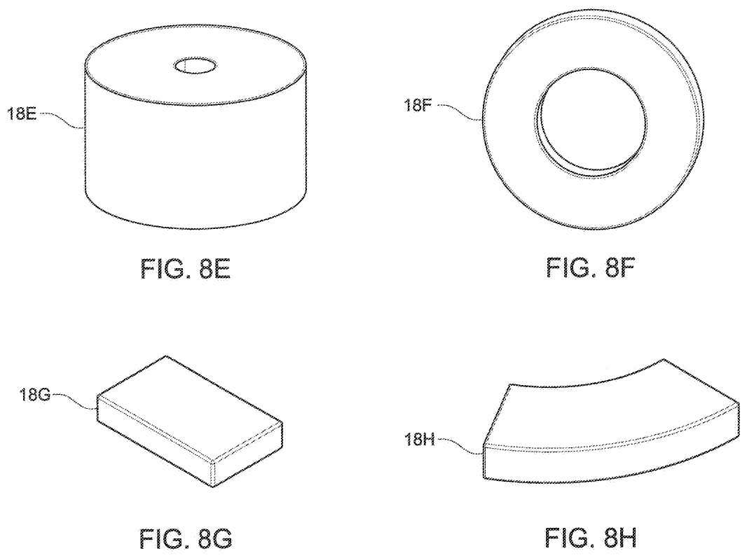

Referring to FIGS. 8A-8H, different geometries for rare earth magnets 18A-18H are illustrated. These include: rare earth magnet 18A (FIG. 8A) having a rectangular block geometry; rare earth rare earth magnet 18B (FIG. 8B) having a semicircular slice geometry; rare earth magnet 18C (FIG. 8C) having a square box geometry; rare earth magnet 18D (FIG. 8D) having a circular plate geometry; rare earth magnet 18E (FIG. 8E) having a cylindrical shape with hollow circular center geometry; rare earth magnet 18F (FIG. 8F) having a circular plate with hollow circular center geometry; rare earth magnet 18G (FIG. 8G) having a rectangular plate geometry; and rare earth magnet 18H (FIG. 8H) having a portion of a donut shape geometry.

Example: In an illustrative embodiment, the system 10 (FIG. 1) produces Nd—Fe—B magnets 18 (FIG. 1A) using a Nd—Fe—B scrap material 26 (FIG. 4) and an additive manufacturing system 14 in the form of a modified EOS M100 3D-Printer manufactured by EOS GmbH Electro Optical Systems.

The system 10 provides a domestic source and manufacturing base for rare earth magnets 18 and super magnets. Additively manufacturing rare earth magnetic scrap materials 26 enables new form factors and performance capabilities. The system 10 is mobile and deployable at Army depots or forward operating bases. The system 10 has produced over 30 alloys for additive manufacturing, melting materials from Magnesium (650 C) to Molybdenum (2,620 C). In addition, Applicant has successfully alloyed multiple elements to form homogeneous alloys including Iron (Fe) and Boron (B). The melting temperature of Neodymium is 1,000 C similar to copper, an element that Applicant routinely processes.

Over 90% of new energy vehicles will be equipped with an Nd—Fe—B permanent magnet motors, about 1 kg per new energy electric (NEVs). NEVs are just one of the Nd—Fe—B market drivers. Future demand will come in developments in wind energy, mobile robotic solutions, drones, electric planes, electric bicycles, electric motorcycles, and consumer electronics.

While a number of exemplary aspects and embodiments have been discussed above, those of skill in the art will recognize certain modifications, permutations, additions and subcombinations thereof. It is therefore intended that the following appended claims and claims hereafter introduced are interpreted to include all such modifications, permutations, additions and sub-combinations as are within their true spirit and scope.

What is claimed is:

1. A system for producing rare earth magnets from a metal powder comprising:
a melting cold hearth atomization system for producing the metal powder from a scrap material, the melting cold hearth atomization system comprising a melting cold hearth system for melting the scrap material into a molten metal, and an atomizer for spheroidizing the molten metal into powder particles forming the metal powder; and
an additive manufacturing system for building the rare earth magnets using the metal powder and an additive manufacturing process.

2. The system of claim 1 wherein the scrap material comprises an element selected from the group consisting of recycled rare earth magnets, recycled metal powder comprising a rare earth element, and recycled metal parts comprising rare earth elements.

3. The system of claim 1 wherein the additive manufacturing system comprises a system selected from the group consisting of a laser powder bed fusion (LPBF) system, a laser metal deposition (LMD) system, an electron beam deposition (EBM) system, a binder jet 3D printing system, and a fused filament fabrication (FFF) system.

4. The system of claim 1 wherein the additive manufacturing system comprises a magnetized build plate.

5. The system of claim 1 wherein the melting cold hearth atomization system is sized for transport in a shipping container.

6. The system of claim 1 further comprising a demagnetizer system for demagnetizing the scrap material.

7. The system of claim 1 further comprising a sieving or cyclonic system for separating the metal powder into units having a desired particle size range.

8. A system for producing rare earth magnets from a metal powder comprising:
a melting cold hearth atomization system for producing the metal powder from a scrap material,
the melting cold hearth atomization system comprising a reactor configured to operate at a vacuum pressure and a melting cold hearth system in the reactor for melting the scrap material into a molten metal, the melting cold hearth system comprising a melting hearth, a plasma torch system for heating the scrap material and a feeder system for feeding the scrap material into the melting hearth without breaking the vacuum pressure;
the melting cold hearth atomization system comprising an atomizer comprising an atomization tower in flow communication with the reactor configured to operate at the vacuum pressure and an atomizing die in the atomization tower having inert gas jets for spheroidizing the molten metal into powder particles, and a collection vessel configured to collect the metal powder without breaking the vacuum pressure; and
an additive manufacturing system for building the rare earth magnets using the metal powder and an additive manufacturing process, the additive manufacturing system comprising a magnetic build plate configured to build the rare earth magnets with a selected geometrical shape.

9. The system of claim 8 wherein the melting cold hearth atomization system is sized for transport in a shipping container.

10. The system of claim 8 further comprising a demagnetizer system for demagnetizing the scrap material.

11. The system of claim 8 wherein the selected geometrical shape has a geometry selected from the group consisting of a rectangular block geometry, a semicircular slice geometry, a square box geometry, a circular plate geometry, a cylindrical shape with hollow circular center geometry, a circular plate with hollow circular center geometry, a rectangular plate geometry, and a portion of a donut shape geometry.

12. The system of claim 8 wherein the feeder system includes a powder feeder for feeding scrap metal powder into the melting hearth.

13. The system of claim 8 wherein the atomization system is selected from the group consisting of atomization die atomizers, and electrode inert gas atomization (EIGA) atomizers.

14. The system of claim 8 wherein the magnetic build plate includes magnetized build areas and support plates.

15. The system of claim 8 further comprising a sieving or cyclonic system for separating the metal powder into units having a desired particle size range.

16. The system of claim 8 wherein the collection vessel includes a sealing assembly that mates with a conduit on the atomization tower.

17. A method for producing rare earth magnets from a metal powder comprising:
providing a scrap material comprising a rare earth metal;
providing a melting cold hearth atomization system for producing the metal powder;
demagnetizing the scrap material;
melting and atomizing the scrap material into the metal powder using the melting cold hearth atomization system;
providing an additive manufacturing system having magnetic build plates; and
building the rare earth magnets using the metal powder and the additive manufacturing system.

18. The method of claim 17 wherein the melting cold hearth atomization system comprises a reactor configured to operate at a vacuum pressure and a melting cold hearth system in the reactor for melting the scrap material into a molten metal, the melting cold hearth system comprising a melting hearth, a plasma torch system for heating the scrap material and a feeder system for feeding the scrap material into the melting hearth without breaking the vacuum pressure.

19. The method of claim 17 wherein the melting cold hearth atomization system comprises an atomizer comprising an atomization tower in flow communication with the reactor configured to operate at the vacuum pressure and an atomizing die in the atomization tower having inert gas jets for spheroidizing the molten metal into powder particles, and a collection vessel configured to collect the metal powder without breaking the vacuum pressure.

20. The method of claim 17 further comprising heat treating the rare earth magnets for magnetic properties.

21. The method of claim 17 wherein the scrap material comprises an element selected from the group consisting of recycled rare earth magnets, recycled metal powder comprising a rare earth element, and recycled metal parts comprising rare earth elements.
